(19) United States
(12) Patent Application Publication
(10) Pub. No.: US 2004/0012197 A1
(43) Pub. Date: Jan. 22, 2004

(54) Flexible hydraulic connection

(76) Inventors: Daniel Guillaud, Cholet (FR); Jean-Michel Paucod, La Seguiniere (FR); Jean-Pierre Serin, Trementines (FR)

Correspondence Address: YOUNG & THOMPSON, 745 SOUTH 23RD STREET 2ND FLOOR, ARLINGTON, VA, 22202

(21) Appl. No.: 10/398,463

(22) PCT Filed: Oct. 24, 2001
(86) PCT No.: PCT/FR01/03297

(30) Foreign Application Priority Data
Oct. 27, 2000 (FR) 00/13799

(51) Int. Cl. F16L 21/00

(52) U.S. Cl. 285/237

(57) ABSTRACT

The invention concerns a flexible hydraulic connection comprising a deformable tube (1) and two rigid sleeves (2). The invention is characterised in that the deformable tube (1) comprises a plastic pipe portion (3) with smooth inner wall, made of flexible thermoplastic material or thermoplastic or thermosetting elastomer, and a retaining device, enclosing said flexible pipe portion (3), consisting of a rigid plastic material and formed with a plurality of rings (4) or at least a helical coil.

The present invention relates generally to hydraulic connections and more particularly flexible hydraulic connections such as drainage connections, evacuation of sanitary water, used water, rainwater or toilet discharge.

This type of flexible hydraulic connection thus comprises at least one deformable tube and at least two sleeves or rigid mail or female joints for end connection.

The present invention also relates to a process for producing such a hydraulic connection.

In general, hydraulic connections proposed for the connection of hydraulic conduits are entirely made of rigid material, by molding of plastic material of the type PVC, ABS, polyethylene, polybutene or polypropylene. They are often made in the form of individual pieces of the elbowed, branched, Y shaped, sleeve, etc . . . The production of the connection thus requires the use of a combination of pieces in the case of an angle connection when the latter differs from the current norms, for example 30°, 45°, 60°, 90°, for achieving alignment. In the case in which use is made of extruded sections, the connection requires delicate manipulation of the material used, for example hot bending of a straight tube so as to bring the latter to the desired shape.

Numerous documents in the prior art, for example EP0 913 611, FR 2 787 548 or FR 2 677 688, propose different embodiments of flexible hydraulic connections permitting facility of forming the connection and permitting all shapes of connection. These latter however have the drawback of being multi-block, which is to say that the sleeves are not of a single piece with the deformable tube but are adapted to the latter by screwing or mechanical joining. This design thus leads to the possibility of the loss of the effluent passing through the connection at the point of this supplemental connection.

Moreover, in general, the deformable tube is of the same material and is generally constituted by a rigid or semi-rigid thermoplastic material having a deformable mechanical structure, such as for example an accordion structure. This structure generally is reproduced within the tube, the surface of the latter thus having points of catching or asperities for the solid particles of the effluents, thereby facilitating plugging of the tube at the level of the deformation and impeding the circulation of the fluid.

Moreover, the small thicknesses of the accordion facilitate degradation of the walls by UV, as well as attacks by the transported chemical products.

Similarly, there has been proposed in EP0 440 566 a tube with a joint of plastic material comprising a tube element having an external surface ringed with, on its external surface, a series of circular waves in relief separated by hollow throats and which one of the ends comprises a hollow fitting to fit over the end of another tube. This tube is constituted by a single plastic material having, for the tube, for the rings and for the hollow fitting, the same properties. This tube is made by injection and pressing to shape according to a conventional extrusion process, from a same and single material and then overmolded with the fitting at one end, which requires manipulations of the semi-finished product and has high production costs.

Deformable tubes of flexible thermoplastic material have also been proposed, but these latter have the drawback of collapsing and in any case having a discontinuous diameter at the deformation or elbow imposed on the flexible connection. A possible metallic reinforcement has been proposed but the latter is complicated to produce and the homogeneity of the connection is weakened. Moreover, a risk of corrosion and hence of weakening of the connection is to be foreseen.

In FR 2 712 371, there has been proposed a flexible connection serving to connect two rigid elements. This connection is constituted by a section of flexible tube which is spirally ringed, which permits it to have on its external surface a screw threading that can coact with internal screwthreading of a ring serving as securement means for one end of the tube on a rigid connection. The screw pitch of the internal screwthreading of the ring is less than that of the external screwthreading of the flexible tube such that during gripping of the ring, there will be a compression of the end of the tube improving sealing and connection. The flexible is obtained by molding from plastic material on a rigid armature wound in a spiral, such as a rigid wire of plastic material, so as to form the screw pitch. There is thus the cladding of the rigid armature by the plastic material. It is thus here a question of forming a screw pitch which will be sufficiently rigid to permit screwing but which does not offer a large amount of flexibility of the tube thus produced because of the cladding of the rigid metallic spiral by the plastic material.

The present invention thus has for its object to overcome these drawbacks by proposing a flexible hydraulic connection such as a connection for the evacuation of sanitary water, wastewater, rain or toilet outlets, of the monoblock type, having a very high flexibility as well as an excellent mechanical strength and thus having a longer life.

To this end, according to the invention, this flexible hydraulic connection, such as a drainage connection, evacuation of sanitary water, wastewater, rain or toilet outlets, comprises at least a deformable tube and at least two rigid sleeves, with a female joint or male end for end connection, said deformable tube comprising a portion of a pipe of plastic material with a smooth internal wall, of flexible thermoplastic material or flexible thermoplastic or thermosetting elastomer, and a support device, surrounding said pipe portion, constituted by a rigid plastic material and formed by a plurality of rings or at least one helical coil, said plastic materials being selected so as to be chemically compatible to ensure anchorage of said support device in the external surface of said side portion.

There is meant by chemically compatible plastic materials, plastic and hot workable polymeric materials having chemical structures or chemical properties permitting obtaining a homogeneous mixture of one in the other without the risk of rejection, of inclusion, encapsulation and so as to obtain preferably a stable and homogeneous composite of an alloyed type.

Such a connection has the advantages of having excellent flexibility without modification of the characteristics of fluid flow, because of the mechanical structure of the support device which it comprises. This device, because of the choice of materials, is secured to the deformable tube and the anchorage that is produced promotes the longevity of the connection. This structure moreover permits avoiding excessive plugging of the connection by the absence of deformation of the internal surface of the tube. This structure thus has high resistance to crushing of the same order as a conventional monoblock rigid connection, but permits diversity of shapes of the formed connection. Moreover, the nature of the material constituting the deformable tube prevents any type of mechanical weakening of the buckling type. The risk of supplemental loss at the sleeves or joints is also avoided because of the choice of the monoblock type of the connection.

Preferably, said rigid sleeves as female joints or male ends and said support device of the hydraulic connection are constituted by the same rigid plastic material.

The choice of identical material for the sleeves or joints and the support device permits moreover decreasing the number of steps necessary for the production of such a connection, which is to say by simplifying the production and thus decreasing the costs of production.

Also preferably, the anchorage of said support device and if desired of said rigid sleeves with female joint or male end, in the external surface of said pipe portion, is carried out by interfusion of the flexible and rigid plastic materials used, in a co-injection operation in a same mold.

This method of carrying out anchorage permits obtaining an excellent cohesion between the two plastic materials used, on the one hand because of their chemical compatibility, and on the other hand because of the creation at the interface, by interpenetration of the flexible and rigid plastic materials, of a composite having a gradient of concentration of the materials relative to each other, which model responds perfectly to the chemical theory of adhesion of two bodies. In this particular case, the chemical compatibility of the two flexible and rigid plastic materials is expressed by good hot miscibility.

More particularly, for this hydraulic connection, the flexible plastic material is selected, as the case may be, from elastomers which are thermosetting of the EPDM type, or which are thermoplastic, or thermoplastics of the flexible PVC or flexible polybutylene type, if desired mixed with additives.

Similarly, for this hydraulic connection, the rigid plastic material is more particularly selected, as the case may be, from thermoplastics such as polypropylene, polyethylene, rigid PVC, rigid ABS or polybutene, if desired mixed with additives.

In particular, there will preferably be selected rigid or flexible plastic materials compatible with each other from among the materials cited above, each of these materials being if desired mixed with additives.

The additives mentioned above will be incorporated in the base used for the plastic material such that the properties of flexibility and rigidity of said materials will not be fundamentally changed. Generally, the quantities used are of the order of 1 to 15%. These additives, currently used in the production of plastic materials, can be selected from among anti-blocking agents, sliding agents, anti-static agents, anti-UV agents, anti-moisture agents, impact modifiers, etc. . . .

A hydraulic connection according to the invention can be provided with rigid sleeves with female joints or male ends to be cemented, or as a modification comprise at least one sealing device included in a rigid sleeve with a female joint. We will thus speak of a connection joint.

In particular, a sealing device according to the invention is a joint constituted principally by a flexible plastic material of the same nature as that constituting said flexible pipe portion. This joint is thus co-injected in the mold at the same time as the flexible pipe.

In this arrangement of a joint connection, the rigid sleeves with a female joint or a male end can comprise at least one longitudinal guide device permitting limitation of the mechanical stresses between said sealing device and the tube to be connected. Such a mechanical stress limiting device could moreover permit facilitating the interfitting of the connection to the principal tube of the conduit system.

Again, the choice of the material can be dictated by the requirements of cost and facilities for production of a connection according to the invention, a restricted choice of material limiting both the complexity of the production of such a connection by the decrease of the number of steps necessary for its production, as well as the costs involved.

A hydraulic connection according to the invention can of course comprise several deformable tubes and/or several rigid sleeves with a female joint or male end for endwise connection to permit the connection of several conduit systems to each other, for example for the connection of several secondary conduit systems to a common collector.

The invention will be understood from a reading of the following description of several embodiments, with reference to the accompanying drawings.

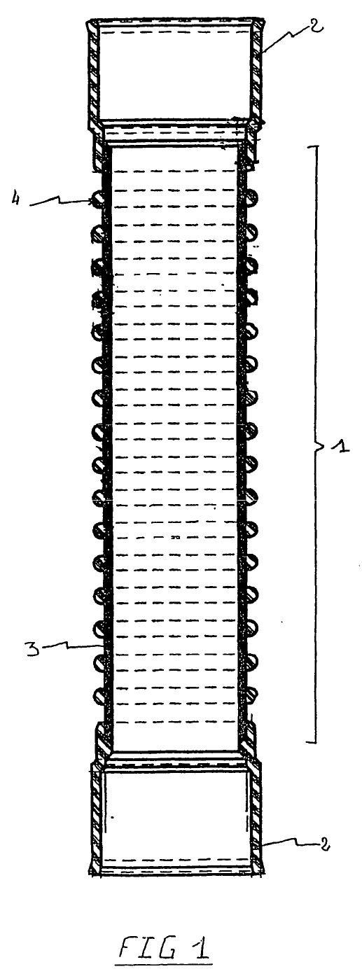

FIG. 1 shows a longitudinal cross-sectional view of a particular embodiment of a flexible connection, comprising rigid sleeves with female joints to be cemented, according to the invention, along its principal axis, also called its generatrix.

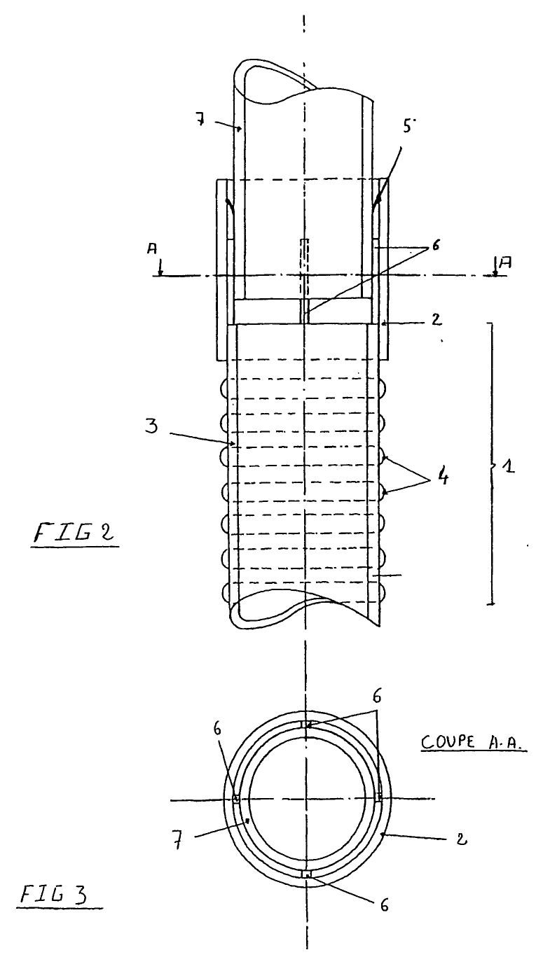

FIG. 2 is a partial longitudinal cross-sectional view of a particular embodiment of a flexible connection, comprising a rigid sleeve with a female joint, according to the invention, along its principal axis again called its generatrix.

FIG. 3 is an axial cross-sectional view of the connection sleeve shown in FIG. 2, along the line A-A.

In FIG. 1 is shown a flexible hydraulic connection, of the monoblock type, comprising a deformable tube 1 and two rigid sleeves 2 with a female joint for endwise connection by cementing. The deformable tube 1 comprises a portion 3 of a flexible pipe with a smooth internal wall, of thermoplastic of the flexible PVC type, ensleeved between the two end sleeves 2 by interfusion at the time of production of the connection. The portion 3 of the flexible pipe is surrounded by a series of rings 4 constituted by a thermoplastic of the rigid PVC type. These rings constitute a support device permitting principally the portion 3 of flexible pipe to keep its diameter no matter what the mechanical stresses imposed on the connection during a connecting operation. Rigid and flexible PVCs, according to the invention, are chemically compatible, which is to say that they permit durable anchoring of the series of rings 4 of rigid PVC, in the surface of the portion 3 of the flexible tube of flexible PVC.

Such compatibility arises here by a similar chemical nature and good hot miscibility of the two materials. These characteristics turn out to be, in this example, the definition of the chemical compatibility of the flexible and rigid thermoplastic materials during the production of the connection by a process of co-injection. There is thus effected, at the surface of the portion 3 of flexible tube, an interfusion of the two PVCs and the creation of a homogeneous composite.

In another modified embodiment not shown here, the series of rings 4 can be replaced by a helical coil surrounding the portion 3 of the flexible pipe. This embodiment confers the same advantages of support as those obtained by said series of rings 4.

Preferably, the sleeves 2 are also made of rigid PVC. This choice moreover permits reducing the cost and time of production of a connection according to the invention and promotes, ideally and in the same manner as described above, the anchoring of the sleeves 2 at the ends of the portion 3 of flexible pipe. In this embodiment, the use of rigid PVC for the joints permits using conventional cementing techniques for the production of assemblies.

In FIG. 2 is partially shown a flexible hydraulic connection, of the monoblock type, comprising a deformable tube 1 and a sleeve 2 with a female joint for connection by joining endwise. The deformable tube 1 comprises a portion 3 of a flexible pipe with a smooth internal wall, of flexible thermoplastic, ensleeved by interfusion at the time of production of the connection, in at least one end sleeve 2 of rigid thermoplastic. The portion 3 of the flexible pipe is surrounded by a series of rings 4 also constituted by a rigid thermoplastic. These rings constitute a support device permitting principally the portion 3 of flexible pipe to keep its diameter no matter what the mechanical stresses imposed on the connection during the act of connecting. This connection also has, anchored in the sleeve 2, a joint with lips 5 permitting obtaining good sealing of the connection to the adjacent tube 7. The sleeve 2 also comprises a longitudinal guide device 6 constituted by four ribs projecting into the sleeve 2. This device permits limiting the mechanical stresses between the joint 5 and the tube 7 to be connected. Such a longitudinal guide device will moreover permit facilitate the ensleeving of the connection to the tube 7 of the conduit system to be connected.

In the same way as for the example shown in FIG. 1, the flexible and rigid thermoplastics are, according to the invention, chemically compatible, and permit durable anchoring of the series of rings 4 in the surface of the portion 3 of flexible pipe. The chemical compatibility is expressed here in the same way as for the example of FIG. 1. There could be cited as an example of embodiment, the combination of a flexible polybutene and of a rigid polybutene.

It follows that modification of embodiment, for example by replacing the series of rings 4 with a helical coil, are entirely envisageable.

FIG. 3 permits moreover visualizing the positioning of the four ribs constituting the longitudinal guide device 6. In this view, the latter are arranged with an angular spacing of 90°. An entirely different configuration involving a different number of ribs or a non-geometric arrangement is entirely envisageable but not shown here. This representation also permits understanding the coaction of the different pieces during connection of the tube 7 to be connected to the sleeve 3.

The present invention also relates to the manner of producing a hydraulic connection according to the invention.

This production process for a flexible hydraulic connection, such as a drain connection, for evacuation of sanitary water, wastewater, rain or toilet outlets, according to the invention, comprises the formation of said portion of flexible pipe as well as said support device and if desired said rigid sleeves with a female joint or male end for endwise connection, within a co-injection mold by successive injection of said chemically compatible plastic materials.

Preferably, the first injection permits producing said holding device as well as if desired simultaneously said rigid sleeves with female joint or male end, and the second injection permits forming said portion of said flexible pipe.

In particular, there is injected at least one sealing device secured to a rigid sleeve with a female joint, simultaneously with said portion of said flexible pipe.

4. (amended) Hydraulic connection according to claim 1, characterized in that the flexible plastic material is selected from thermosetting elastomers of the EPDM type or thermoplastics, of the flexible PVC or flexible polybutene type, if desired mixed with additives.

5. (amended) Hydraulic connection according to claim 1, characterized in that the rigid plastic material is selected from thermoplastics such as polypropylene, polyethylene, rigid PVC, ABS or rigid polybutene, if desired mixed with additives.

6. (amended) Hydraulic connection according to claim 4, characterized in that the rigid and flexible plastic materials are compatible with each other, each of these materials being if desired mixed with additives.

7. (amended) Hydraulic connection according to claim 1, characterized in that it comprises at least two rigid sleeves (2) with a female joint or a male end to be cemented or that it comprises at least one sealing device (5) included in each sleeve (2) with a female joint.

9. (amended) Hydraulic connection according to any claim 7, characterized in that the sleeves (2) comprise at least one longitudinal guide device (6) permitting the limitation of the mechanical stresses between said sealing device and the tube to be connected.

10. (amended) Process for the production of a flexible hydraulic connection, such as a drain connection, for evacuation of sanitary water, wastewater, rain or toilet outlets, according to claim 1, characterized in that said portion (3) of flexible tube as well as said support device (4) and if desired said rigid sleeves (2) with female joint or male end for endwise connection, are formed in a mold by co-injection by successive injection of said chemically compatible plastic materials.

12. (amended) Process for production according to claim 10, characterized in that there is injected at least one sealing device (5) secured to a rigid sleeve (2) with a female joint simultaneously with said portion (3) of said flexible pipe.

1. Flexible hydraulic connection, such as a drain connection, for evacuation of sanitary water, wastewater, rain or toilet outlets, comprising at least one deformable tube (1) and at least two rigid sleeves (2) with a female joint or male end for endwise connection,
characterized in that said deformable tube (1) comprises a portion (3) of a tube of plastic material with a smooth internal wall, of flexible thermoplastic material or of thermoplastic or thermosetting elastomer, and a support device, surrounding said portion (3) of flexible pipe, comprising a rigid plastic material and formed of a plurality of rings (4) or of at least one helical coil, said plastic materials being selected so as to be chemically compatible so as to ensure anchoring of said support device in the external surface of said portion (3) of flexible pipe.

2. Hydraulic connection according to claim 1,
characterized in that said rigid sleeves (2) with a female joint or male end and said support device (4) are constituted by the same rigid plastic material.

3. Hydraulic connection according to any one of claims 1 and 2,
characterized in that the anchoring of said support device (4) and if desired of said rigid sleeves (2) with female joint or male end in the external surface of said portion (3) of the pipe of flexible plastic material is carried out by interfusion of the flexible and rigid plastic materials used in an operation of co-injection in a same mold.

4. Hydraulic connection according to any one of claims 1 to 3,
characterized in that the flexible plastic material is selected from thermosetting elastomers of the EPDM type or thermoplastics, of the flexible PVC or flexible polybutene type, if desired mixed with additives.

5. Hydraulic connection according to any one of claims 1 to 4,
characterized in that the rigid plastic material is selected from thermoplastics such as polypropylene, polyethylene, rigid PVC, ABS or rigid polybutene, if desired mixed with additives.

6. Hydraulic connection according to any one of claims 4 and 5,
characterized in that the rigid and flexible plastic materials are compatible with each other, each of these materials being if desired mixed with additives.

7. Hydraulic connection according to any one of claims 1 to 6,
characterized in that it comprises at least two rigid sleeves (2) with a female joint or a male end to be cemented or that it comprises at least one sealing device (5) included in each sleeve (2) with a female joint.

8. Hydraulic connection according to claim 7,
characterized in that said sealing device (5) is a joint with lips constituted principally of a flexible plastic material of the same nature as that constituting said portion (3) of the flexible pipe.

9. Hydraulic connection according to any one of claims 7 and 8,
characterized in that the sleeves (2) comprise at least one longitudinal guide device (6) permitting the limitation of the mechanical stresses between said sealing device and the tube to be connected.

10. Process for the production of a flexible hydraulic connection, such as a drain connection, for evacuation of sanitary water, wastewater, rain or toilet outlets, according to any one of claims 1 to 9,
characterized in that said portion (3) of flexible tube as well as said support device (4) and if desired said rigid sleeves (2) with female point or male end for endwise connection, are formed in a mold by co-injection by successive injection of said chemically compatible plastic materials.

11. Process for production according to claim 10,
characterized in that the first injection permits forming said support device (4) and if desired said rigid sleeves (2) with female joint or male end and the second injection permits forming said portion (3) of said flexible pipe.

12. Process for production according to any one of claims 10 and 11,
characterized in that there is injected at least one sealing device (5) secured to a rigid sleeve (2) with a female joint simultaneously with said portion (3) of said flexible pipe.
